(19) United States
(12) Patent Application Publication
(10) Pub. No.: US 2018/0004563 A1
(43) Pub. Date: Jan. 4, 2018

(54) ORCHESTRATOR APPARATUS, SYSTEM, VIRTUAL MACHINE CREATION METHOD, AND COMPUTER-READABLE RECORDING MEDIUM

(71) Applicant: NEC CORPORATION, Tokyo (JP)

(72) Inventor: Tomoaki MIYAZAKI, Tokyo (JP)

(73) Assignee: NEC CORPORATION, Tokyo (JP)

(21) Appl. No.: 15/544,035

(22) PCT Filed: Jan. 26, 2016
(86) PCT No.: PCT/JP2016/052125

§ 371 Date: Jul. 17, 2017

(30) Foreign Application Priority Data
Jan. 27, 2015 (JP) 2015-013736

(51) Int. Cl. G06F 9/455

(52) U.S. Cl. CPC G06F 9/45558; G06F 2009/45595; G06F 2009/45562; G06F 2009/4557

(57) ABSTRACT

An orchestrator apparatus includes: a virtualized infrastructure control unit that supplies information about a virtual network created by one of first and second virtualized infrastructure management units to the other virtualized infrastructure management unit and causes the other virtualized infrastructure management unit to create a virtual network virtually connectable to the virtual network created by said one virtualized infrastructure management unit; and a virtual machine creation control unit that causes, when a virtual machine is created on the second virtualized infrastructure, an address management function of the first virtualized infrastructure management unit to create an address(es) that is to set in a virtual port of the virtual machine, supplies the address(es) to the second virtualized infrastructure, and causes the second virtualized infrastructure management unit to create a virtual machine on the second virtualized infrastructure.

### REFERENCE TO RELATED APPLICATION

This application is a National Stage of International Application No. PCT/JP2016/052125, filed on Jan. 26, 2016, which claims the benefit of the priority of Japanese patent application No. 2015-013736, filed on Jan. 27, 2015, the disclosure of which is incorporated herein in its entirety by reference thereto.

### FIELD

The present invention relates to an orchestrator apparatus, a system, a virtual machine creation method, and a program. In particular, it relates to a function of creating a virtual machine(s) on a virtualized infrastructure.

### BACKGROUND

As a technique to virtualize computing, storage, network functions, etc. of a server, for example, there is known NFV (Network Functions Virtualization). In NFV, the virtualization is realized as software by virtual machines (VMs) implemented on a virtualization layer such as a HyperVisor on a server. For example, the NFV is realized based on a MANO (Management & Orchestration) architecture. FIG. 1 is FIG. 5.1 (The NFV-MANO architectural framework with reference points) on page 23 in NPL 1.

As illustrated in FIG. 1, an individual VNF (Virtual Network Function) corresponds to an application(s), etc. that operates on a virtual machine (VM) on a server and realizes network functions as software. For example, the VNF may realize an MME (Mobility Management Entity), an S-GW (Serving Gateway), a P-GW (PDN Gateway), or the like in EPC (Evolved Packet Core), which is a core network of an LTE (Long Term Evolution) network, by using software (a virtual machine). In the example in FIG. 1, a management function called an EM (Element Manager) is arranged per VNF.

NFVI (Network Function Virtualization Infrastructure) is an execution infrastructure for VNFs. More specifically, the NFVI is an infrastructure where hardware resources of a physical machine (server) such as for computing, storage, or network functions are virtualized in a virtualization layer such as a hypervisor to be flexibly used as virtualized hardware resources such as for virtualized computing, virtualized storage, or virtualized networking.

NFV MANO (Management & Orchestration) includes an NFV-Orchestrator (NFVO), a VNF-Manager (VNFM), and a Virtualized Infrastructure Manager (VIM).

The NFV-Orchestrator (NFVO) performs the orchestration of NFVI Resources and the lifecycle management of NSs (Network Services) (instantiation, scaling, termination, update, etc. of NS instances). In addition, the NFVO manages an individual NS Catalog (NSD/VLD/VNFFGD) and an individual VNF Catalog (VNFD/VM images/manifest files, etc.) and holds an NFV Instances repository and an NFVI Resources repository.

The VNF-Manager (VNFM) performs VNF lifecycle management (instantiation, update, query, scaling, termination, (assisted/automated) healing, etc.) and event notification.

The Virtualized Infrastructure Manager (VIM) controls the NFVI via a virtualization layer (computing, storage, network resources management, fault monitoring on the NFVI, which is an NFV execution infrastructure, resource information monitoring, etc.).

OSS (Operation Service Systems) is a general term for systems (apparatuses, software, mechanisms, etc.) needed by telecommunication carriers (carriers) to establish and operate services, for example. BSS (Business Service Systems) is a general term for information systems (apparatuses, software, mechanisms, etc.) that telecommunication carriers (carriers) use for charging usage fees, billing, and customer care, for example.

The NS Catalog represents a repository of Network Services (NS). The NS Catalog supports creation and management of Network Services (NS) deployment templates (Network Service Descriptor (NSD), Virtual Link Descriptor (VLD), and VNF Forwarding Graph Descriptor (VNFFGD)). Deployment means customizing network services in accordance with required specifications, etc. and deploying the customized network services to an actual use environment.

The VNF Catalog represents a repository of VNF Packages. The VNF Catalog supports creation and management of the VNF Packages such as VNF Descriptor (VNFD), software images, and manifest files.

The NFV Instances repository holds information about all VNF instances and Network Service (NS) instances. Each VNF instance is represented by a VNF record, and each NS instance is represented by an NS record. These records are updated during the lifecycles of the respective instances, reflecting results of execution of VNF lifecycle management operations and NS lifecycle management operations.

The NFVI Resources repository holds information about available/reserved/allocated resources extracted by the VIM across operator's infrastructure domains.

In FIG. 1, a reference point Os-Nfvo is a reference point arranged between the OSS (Operation Service Systems)/BSS (Business Service Systems) and the NFVO and is used for network service lifecycle management requests, VNF lifecycle management requests, forwarding of state information regarding NFV, exchanges of policy management information, etc.

A reference point Vnfm-Vi is used for resource allocation requests from the VNFM and exchanges of information about configurations and states of virtualized resources.

A reference point Ve-Vnfm-em is used between the EM and the VNFM for VNF instantiation, VNF instance query, update, termination, scaling out/in, scaling up/down, forwarding of configurations and events from the EM to the VNFM, and notification of configurations of the VNF and events from the VNFM to the EM, for example.

A reference point Ve-Vnfm-Vnf is used between the VNF and the VNFM for VNF instantiation, VNF instance query, update, termination, scaling out/in, scaling up/down, forwarding of configurations and events from the VNF to the VNFM, and notification of configurations of the VNF and events from the VNFM to the VNF, for example.

A reference point Nf-Vi is used for giving instructions to manage computing, storage, and network resources, allocation of a VM(s), updating VM resources allocation, VM migration, VM termination, creating and removing connection between VMs, etc., allocation of virtualized resources in response to resources allocation requests, forwarding of state information about virtualized resources, and exchanges of the configuration and state information about hardware resources, for example.

A reference point Vn-Nf represents an execution environment provided by the NFVI for the VNF.

A reference point Nfvo-Vnfm is used for resource-related requests (authorization, reservation, allocation, etc.) from the VNF-Manager (VNFM), forwarding of configuration information to the VNFM, and collection of state information about the VNF.

A reference point Nfvo-Vi is used when the NFVO performs resource reservation, makes allocation requests, and exchanges information about configurations and states of virtualized resources (see NPL 1 for details).

NPL 1: ETSI GS NFV-MAN 001 V1.1.1 (2014-12) Network Functions Virtualisation (NFV); Management and Orchestration <http://www.etsi.org/deliver/etsi_gs/NFV-MAN/001_099/001/01.01.01_60/gs_NFV-MAN001v010101p.pdf>

### SUMMARY

The following analysis has been given by the present invention. In the future, NFV VIMs (virtualized infrastructure management units) as described above could be arranged at different bases. In such cases, it is anticipated that users may wish to connect two or more virtual networks configured by two or more VIMs (virtualized infrastructure management units) so as to configure a cooperation network.

However, whether each of the two or more VIMs (virtualized infrastructure management units) uses a unique virtual network type or the same virtual network type, if virtual network IDs are different, these VIMs cannot directly be connected, which is counted as a problem.

In addition, even if virtual networks provided by two or more VIM (virtualized infrastructure management units) have successfully been connected, virtual machines (VMs) that exist in the respective virtual networks may have the same address. Thus, there is a problem that another device such as a NAT (Network Address Translation) function or a gateway is needed.

It is an object of the present invention to provide an orchestrator apparatus, a system, a virtual machine creation method, and a program that can contribute to enhancement of a technique of connecting virtual networks configured by two or more VIMs (virtualized infrastructure management units).

According to a first aspect, there is provided an orchestrator apparatus connected to a first virtualized infrastructure management unit that includes an address management function and manages a first virtualized infrastructure and to a second virtualized infrastructure management unit that manages a second virtualized infrastructure. This orchestrator apparatus includes: a virtualized infrastructure control unit that supplies information about a virtual network created by one of the first and second virtualized infrastructure management units to the other virtualized infrastructure management unit and causes the other virtualized infrastructure management unit to create a virtual network virtually connectable to the virtual network created by said one virtualized infrastructure management unit; and a virtual machine creation control unit that causes, when a virtual machine is created on the second virtualized infrastructure, the address management function of the first virtualized infrastructure management unit to create an address(es) that is to set in a virtual port of the virtual machine, supplies the address(es) to the second virtualized infrastructure, and causes the second virtualized infrastructure management unit to create a virtual machine on the second virtualized infrastructure.

According to a second aspect, there is provided a virtual network function providing system including the above orchestrator apparatus.

According to a third aspect, there is provided a virtual machine creation method, executed by an orchestrator apparatus connected to a first virtualized infrastructure management unit that includes an address management function and manages a first virtualized infrastructure and to a second virtualized infrastructure management unit that manages a second virtualized infrastructure. This virtual machine creation method includes: supplying information about a virtual network created by one of the first and second virtualized infrastructure management units to the other virtualized infrastructure management unit and causing the other virtualized infrastructure management unit to create a virtual network virtually connectable to the virtual network created by said one virtualized infrastructure management unit; and causing, when a virtual machine is created on the second virtualized infrastructure, the address management function of the first virtualized infrastructure management unit to create an address(es) that is to set in a virtual port of the virtual machine, supplying the address(es) to the second virtualized infrastructure, and causing the second virtualized infrastructure management unit to create a virtual machine on the second virtualized infrastructure. This method is associated with a certain machine called an orchestrator apparatus that controls two or more virtualized infrastructure management units.

According to a fourth aspect, there is provided a non-transitory computer-readable recording medium storing thereon a computer program executed by the above orchestrator apparatus. This program can be recorded in a computer-readable (non-transient) storage medium. Namely, the present invention can be embodied as a computer program product.

Each element of the above orchestrator apparatus, system, virtual machine creation method, and program contributes to solving the above problems.

The meritorious effects of the present invention are summarized as follows.

The present invention can contribute to enhancement of a technique of connecting virtual networks configured by two or more VIMs (virtualized infrastructure management units). In addition, the present invention can transform the orchestrator apparatus described in the above Background into an orchestrator apparatus having an orchestration function of achieving network cooperation without a contradiction.

### BRIEF DESCRIPTION OF THE DRAWINGS

FIG. 1 illustrates NFV-MANO in an NFV architecture (cited from FIG. 5.1 in NPL 1).

FIG. 2 illustrates a configuration of a virtual network function providing system and an orchestrator apparatus according to a first exemplary embodiment of the present disclosure.

FIG. 3 is a sequence diagram illustrating an operation performed by the orchestrator apparatus when the orchestrator apparatus receives a first VM creation request from a user.

FIG. 4 illustrates the operation performed by the orchestrator apparatus according to the first exemplary embodiment of the present disclosure.

FIG. 5 is a sequence diagram illustrating an operation performed by the orchestrator apparatus when the orchestrator apparatus receives a second VM creation request from a user.

FIG. 6 illustrates an operation (temporary creation of a virtual port) performed by the orchestrator apparatus according to the first exemplary embodiment of the present disclosure.

FIG. 7 illustrates an operation (creation of a virtual NW) performed by the orchestrator apparatus according to the first exemplary embodiment of the present disclosure.

FIG. 8 illustrates an operation (creation of a virtual port) performed by the orchestrator apparatus according to the first exemplary embodiment of the present disclosure.

FIG. 9 illustrates an operation (creation of a VM) performed by the orchestrator apparatus according to the first exemplary embodiment of the present disclosure.

FIG. 10 is a sequence diagram illustrating an operation performed by an orchestrator apparatus according to a second exemplary embodiment of the present disclosure.

### DESCRIPTION OF EMBODIMENTS

### First Exemplary Embodiment

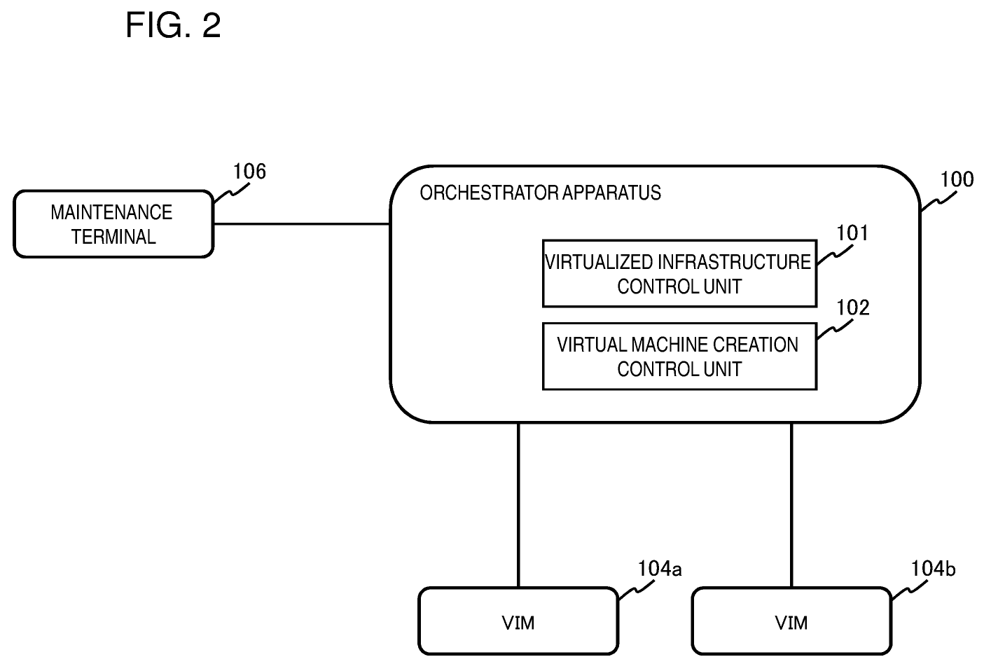

Next, a first exemplary embodiment of the present disclosure will be described in detail with reference to drawings. FIG. 2 illustrates a configuration of a virtual network function providing system according to the first exemplary embodiment of the present disclosure.

As illustrated in FIG. 2, an orchestrator apparatus 100 connected to a maintenance terminal 106 is connected to VIMs 104a and 104b that control NFVIs (Network Function Virtualization Infrastructures), which are VNF execution infrastructures.

The maintenance terminal 106 is a terminal corresponding to the OSS/BSS described in the above Background. For example, this maintenance terminal 106 also correspond to an upper apparatus that receives a VM creation request from a user and transmits the VM creation request to the orchestrator apparatus 100.

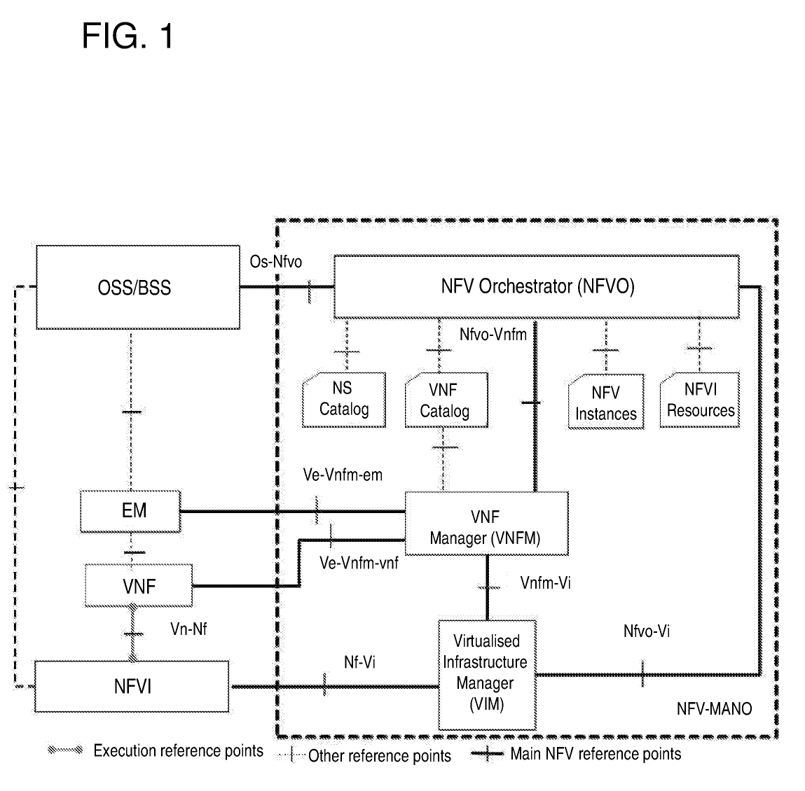

An individual one of the VIMs 104a and 104b manages a virtualized infrastructure serving as a VM operation infrastructure in accordance with instructions from the orchestrator apparatus 100. In addition, based on a request from the orchestrator apparatus 100, an individual one of the VIMs 104a and 104b creates a VM in coordination with a VNF manager not illustrated in FIG. 2 (see “VNFM” in FIG. 1). VIMs equivalent to those in NPL 1 may be used as the VIMs 104a and 104b. The VIMs correspond to the above virtualized infrastructure management units. The present exemplary embodiment will be described assuming that each of the VIMs 104a and 104b exists at a different base.

In accordance with user instructions received via the maintenance terminal 106, the orchestrator apparatus 100 controls the VIMs 104a and 104b. In addition, the orchestrator apparatus 100 provides the maintenance terminal 106 with information needed for operation support of network services, billing management, customer management, etc. The orchestrator apparatus 100 according to the present exemplary embodiment includes a virtualized infrastructure control unit 101 and virtual machine (VM) creation control unit 102.

The virtualized infrastructure control unit 101 supplies information about a virtual network created by one (for example, 104a) of the VIMs 104a and 104b (corresponding to the above first and second virtualized infrastructure management units) to the other VIM (for example, 104b) and causes the other VIM (for example, 104b) to create a virtual network virtually connectable to the virtual network created by the one VIM.

When an VIM (for example, 104b) that does not use an address management function creates a VM, the virtual machine (VM) creation control unit 102 causes a VIM (for example, 104a) that has an address management function and serves as a master to create addresses to be set in a virtual port of this VM. Next, the virtual machine (VM) creation control unit 102 provides the VIM (for example, 104b) that does not use an address management function with the addresses created by the VIM (for example, 104a) that has the address management function and serves as a master. In this way, a VM is created on the second virtualized infrastructure.

Each unit (processing means) of the orchestrator apparatus 100 illustrated in FIG. 2 may be realized by a computer program causing a computer constituting the orchestrator apparatus 100 to user its hardware and perform the above processing.

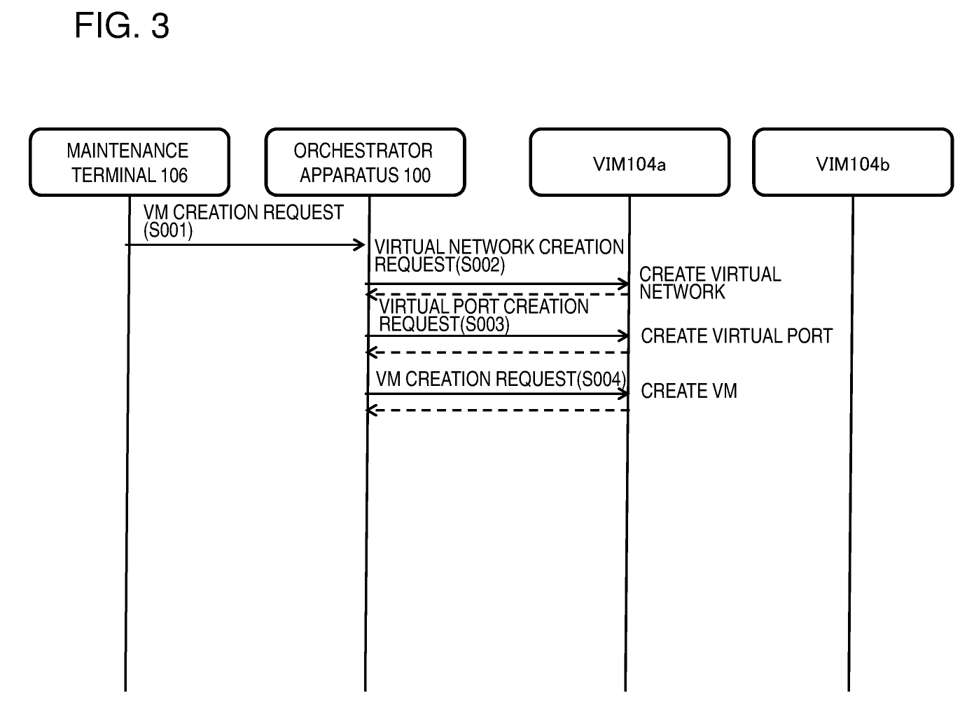

Next, an operation according to the present exemplary embodiment will be described in detail with reference to the drawings. The following description will be made based on an example in which the orchestrator apparatus 100 receives a request from a user, creates a virtual network connected to the VIMs 104a and 104b, and creates a VM on the virtual network. FIG. 3 is a sequence diagram illustrating an operation performed by the orchestrator apparatus when the orchestrator apparatus receives a first VM creation request from a user. As illustrated in FIG. 3, first, the orchestrator apparatus 100 receives a VM creation request from the maintenance terminal 106 (step S001). When receiving the request, the orchestrator apparatus 100 requests the VIM 104a to create a virtual network on which the VM is to be operated (step S002).

When receiving a response, which indicates that the requested virtual network has been created, from the VIM 104a (see an arrow indicated by a dashed line in FIG. 3), the orchestrator apparatus 100 requests the VIM 104a to create a virtual port assigned to a virtual NIC (a network interface card) of the target VM (step S003).

When receiving a response, which indicates that the requested virtual port has been created, from the VIM 104a (see an arrow indicated by a dashed line in FIG. 3), the orchestrator apparatus 100 requests the VIM 104a to create a VM by specifying the IP and MAC addresses of the created virtual port (step S004). The VIM 104a creates a VM by using the specified IP and MAC addresses.

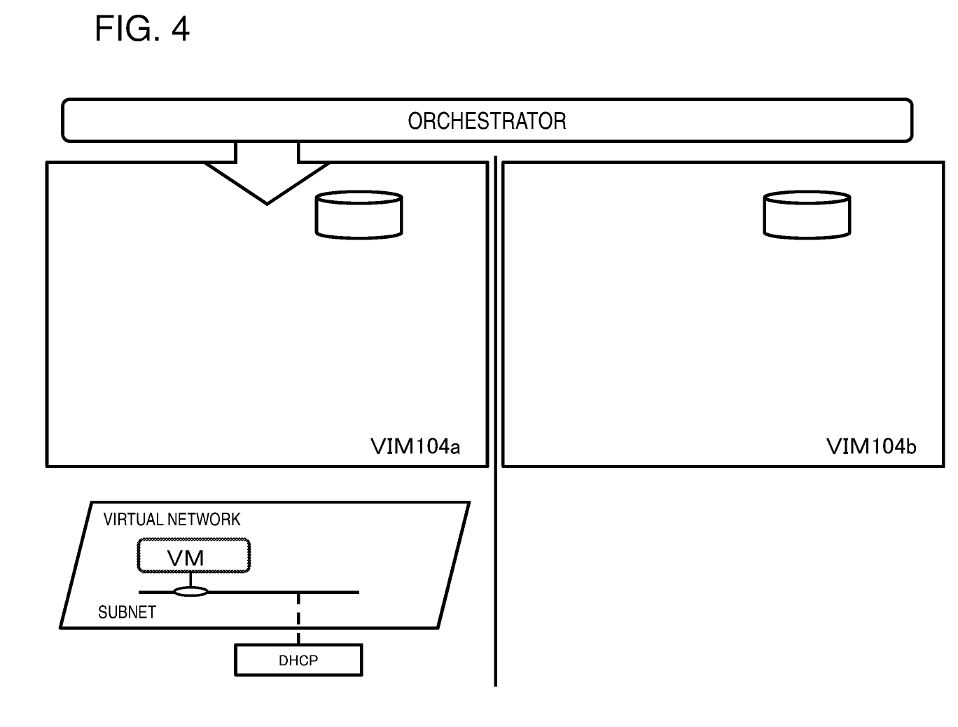

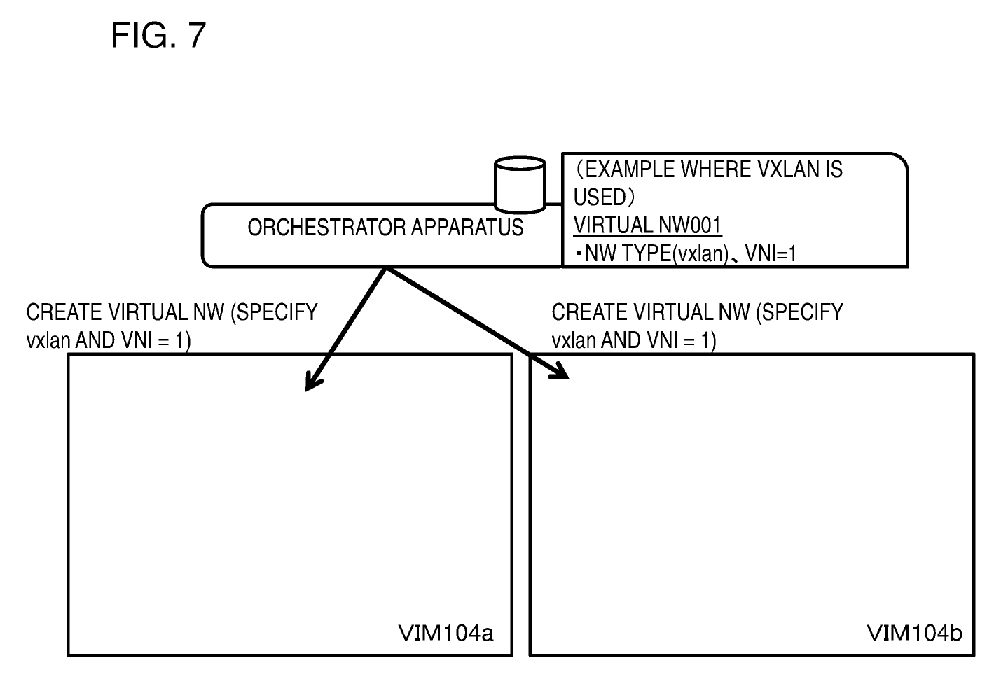

FIG. 4 illustrates the virtual network and the VM thereon created by the VIM 104a. In FIG. 4, the VM created by the VIM 104a is connected to the virtual port created in step S003. In addition, as illustrated in FIG. 4, the following description assumes that a DHCP (Dynamic Host Configuration Protocol) server is arranged on the virtual network created by the VIM 104a. This DHCP server does not always need to be configured by hardware. For example, a DHCP function of a virtual network function (VNF) configured by the VIM 104a may alternatively be used. As illustrated in FIG. 4, where to arrange the address management function such as the DHCP server may be determined when the virtual network is created. Alternatively, where to arrange the address management function may be determined again when a second virtual network is created as illustrated in FIG. 7. For example, the address management function may be arranged on a virtual network created first or on a virtual network of one of the VIMs 104a and 104b that has more available resources.

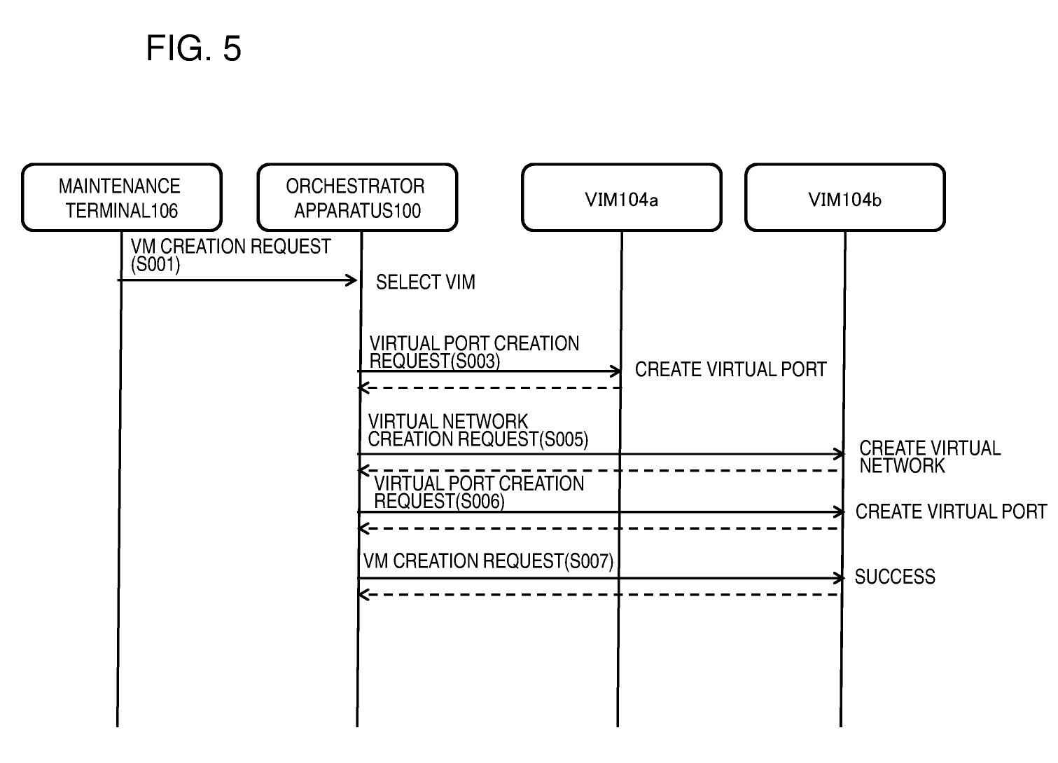

Next, the orchestrator apparatus receives a second VM creation request from a user. FIG. 5 is a sequence diagram illustrating an operation performed by the orchestrator apparatus 100 when the orchestrator apparatus 100 receives a second VM creation request.

As illustrated in FIG. 5, when receiving a second VM creation request from a user, the orchestrator apparatus 100 selects a VIM that is to create a VM by using a predetermined rule. For example, by using location information about the user, the orchestrator apparatus 100 may select the nearest VIM as the VIM that is to create a VM. Alternatively, the orchestrator apparatus 100 may select the VIM that is to create a VM in view of the resources or load of an individual VIM. The following description will be made assuming that the orchestrator apparatus 100 has selected the VIM 104b. If the orchestrator apparatus 100 has selected the VIM 104a, the same processing as in FIG. 3 is performed.

Even when the orchestrator apparatus 100 has selected the VIM 104b as the virtualized infrastructure on which the VM is to be created, the orchestrator apparatus 100 requests the VIM 104a, on which the DHCP server is arranged, to create a virtual port (step S003). In this way, the orchestrator apparatus 100 acquires address information (IP and MAC addresses) to be set in the newly created VM.

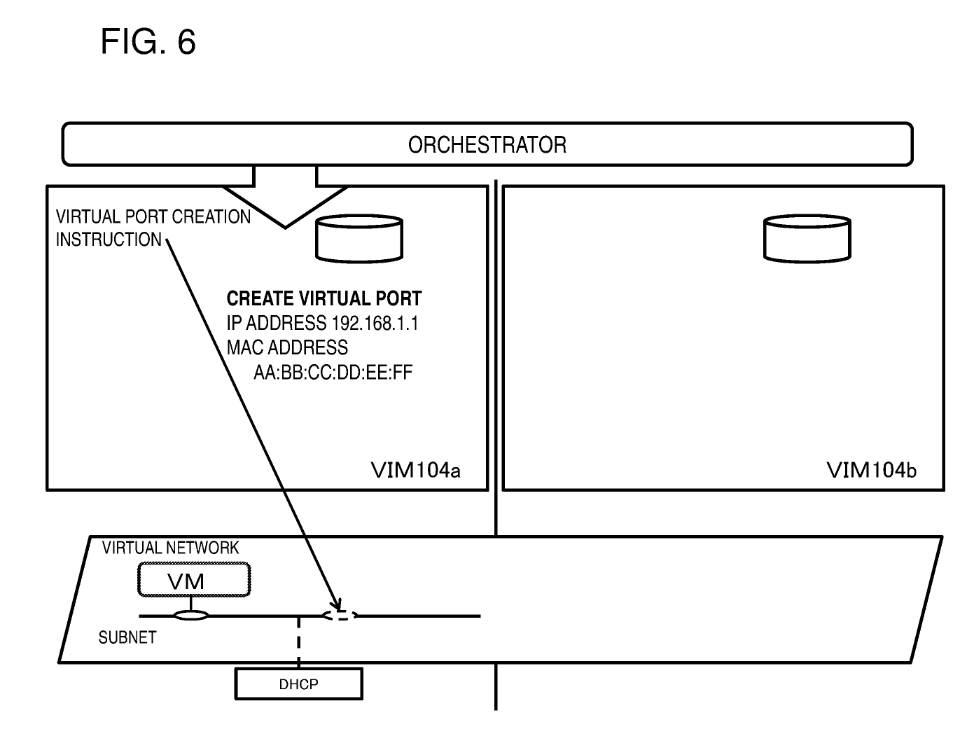

FIG. 6 illustrates processing for temporarily creating a virtual port performed by the orchestrator apparatus 100. As illustrated in FIG. 6, by instructing the VIM 104a to create a virtual port, the orchestrator apparatus 100 acquires IP and MAC addresses unique to the virtual network of the VIM 104a.

Next, the orchestrator apparatus 100 requests the VIM 104b to create a virtual network on which the VM is to be operated (step S005). The orchestrator apparatus 100 causes the VIM 104b to create a new virtual network by specifying a type and a network ID of the newly created virtual network.

FIG. 7 illustrates an operation in which the orchestrator apparatus 100 instructs a VIM to create a virtual network. For example, if a VIM 104a has already created a virtual network whose network type is VXLAN (Virtual eXtensible Local Area Network) and whose network ID (VNI) is 1, the orchestrator apparatus 100 requests the VIM 104b to create a virtual network by specifying the network type VXLAN (Virtual eXtensible Local Area Network) and the network ID (VNI) 1. In this way, the two virtual networks can be connected. The network type is not limited to VXLAN. Another network type using a tunneling technique such as NVGRE (Network Virtualization using Generic Routing Encapsulation) or STT (Stateless Transport Tunneling) is applicable. In such a case, a TNI (Tenant-ID) or a Context ID is specified as the network ID.

When receiving a response, which indicates that the requested virtual network has been created, from the VIM 104b (see an arrow indicated by a dashed line in FIG. 5), the orchestrator apparatus 100 requests the VIM 104b to create a virtual port assigned to a virtual NIC (a network interface card) of the target VM by specifying the IP and MAC addresses acquired in step S003 (step S006).

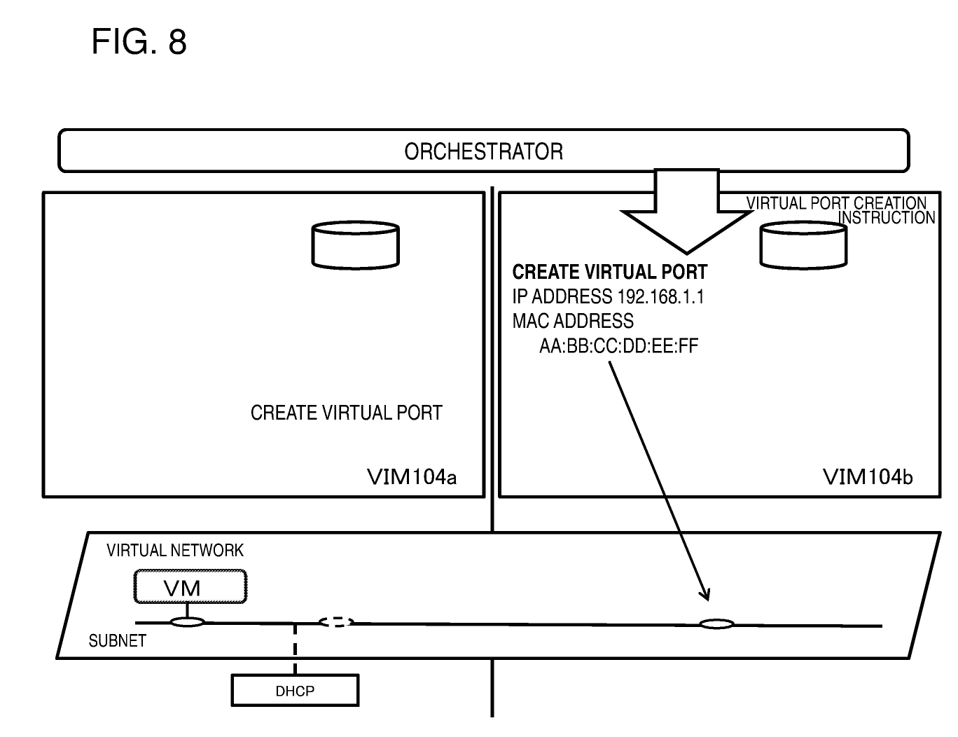

FIG. 8 illustrates processing for creating a virtual port performed by the orchestrator apparatus 100. As illustrated in FIG. 8, the orchestrator apparatus 100 requests the VIM 104b to create a virtual port by specifying the IP and MAC addresses acquired in step S003. In the example of FIG. 8, a virtual port having the IP address (192.168.1.1) and the MAC address (AA:BB:CC:DD:EE:FF) acquired in step S003 has been created. As described above, since these IP and MAC addresses have been created by the VIM 104a, uniqueness of these addresses is ensured.

When receiving a response, which indicates that the requested virtual port has been created, from the VIM 104b (see an arrow indicated by a dashed line in FIG. 5), the orchestrator apparatus 100 requests the VIM 104b to create a VM by specifying the IP and MAC addresses of the created virtual port (step S007). The VIM 104b creates a VM by using the specified IP and MAC addresses.

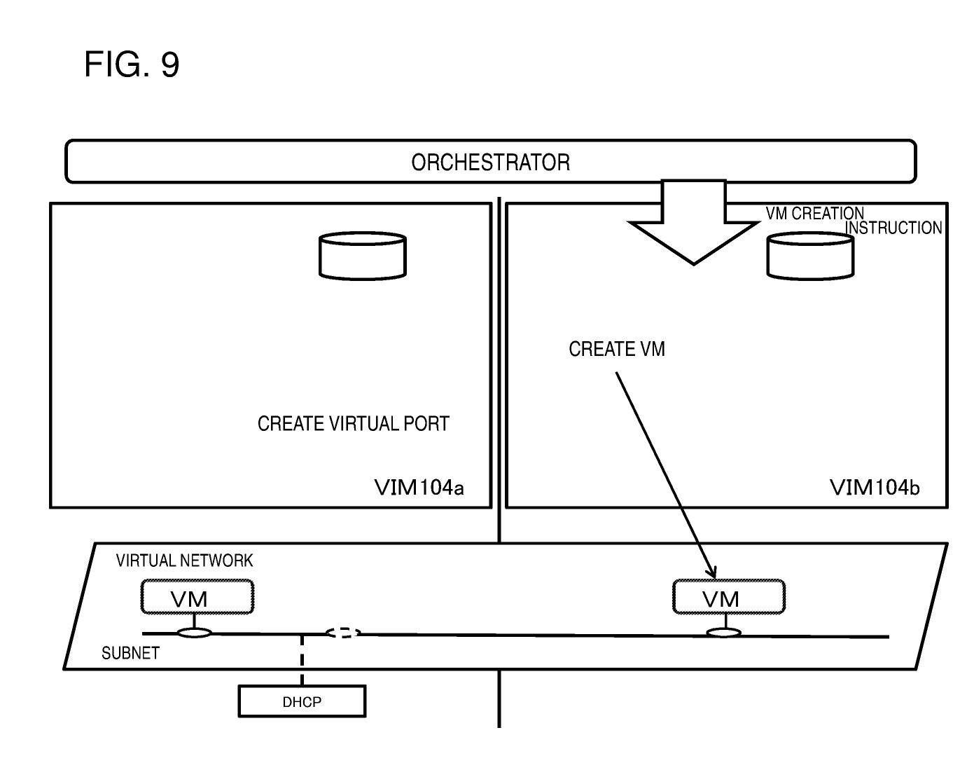

FIG. 9 illustrates processing for creating a VM performed by the orchestrator apparatus 100. As illustrated in FIG. 9, the orchestrator apparatus 100 requests the VIM 104b to create a VM by specifying the IP and MAC addresses acquired in step S003. In the example of FIG. 9, a VM is connected to the virtual port created in step S006. This VM exists on the same virtual network on which the VM on the VIM 104aside exists and can communicate with the VM on the VIM 104a side. It should be noted that, since uniqueness of the IP and MAC addresses set in the virtual port is ensured, no NAT or gateway needs to be arranged.

As described above, the present exemplary embodiment enables not only connection of virtual networks configured by two or more VIMs (virtualized infrastructure management units) but also creation of a VM by selecting an arbitrary VIM. Thus, even when resources at one base are insufficient, a VM can be created with resources at another base.

### Second Exemplary Embodiment

Next, a second exemplary embodiment will be described in detail with reference to a drawing. An orchestrator apparatus 100 according to the second exemplary embodiment operates differently from the orchestrator apparatus 100 according to the above first exemplary embodiment. Since the present exemplary embodiment can be realized by the same configuration as that according to the first exemplary embodiment, the present exemplary embodiment will be described with a focus on the difference.

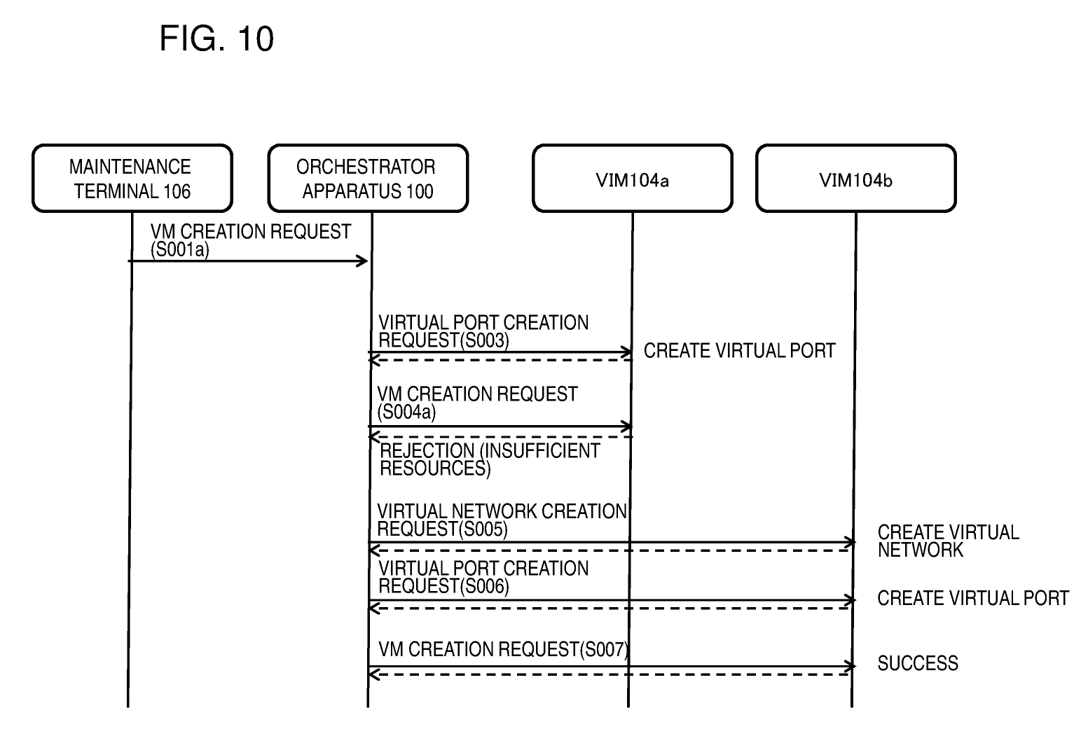

FIG. 10 is a sequence diagram illustrating an operation performed when the orchestrator apparatus 100 according to the second exemplary embodiment of the present disclosure receives a second VM creation request. The second exemplary embodiment differs from the first exemplary embodiment in that the orchestrator apparatus 100 first makes an attempt to cause the previously set VIM 104a to create a VM in step S001a, instead of selecting a VIM that is to create a VM by using a predetermined rule.

The present exemplary embodiment is the same as the first exemplary embodiment in that the orchestrator apparatus 100 requests the VIM 104a to create a virtual port.

When receiving a response, which indicates that the requested virtual port has been created, from the VIM 104a (see an arrow indicated by a dashed line in FIG. 10), the orchestrator apparatus 100 requests the VIM 104a to create a VM by specifying the IP and MAC addresses of the created virtual port (step S004a). If the VIM 104a can create a VM, the VIM 104a creates a VM in accordance with the sequence illustrated in FIG. 3. The following description assumes that the response from the VIM 104a indicates that the VIM 104a cannot create the VM because of its insufficient resources.

In this case, another VIM serves to substitute for the VIM 104a. Namely, the orchestrator apparatus 100 requests the VIM 104b to create a virtual network on which the VM is to be operated (step S005). In this case, too, as in the first exemplary embodiment, the orchestrator apparatus 100 causes the VIM 104b to create a virtual network by specifying a type and a network ID of the newly created virtual network.

When receiving a response, which indicates that the requested virtual network has been created, from the VIM 104b (an arrow indicated by a dashed line in FIG. 10), the orchestrator apparatus 100 requests the VIM 104b to create a virtual port assigned to a virtual NIC (a network interface card) of the target VM by specifying the IP and MAC addresses acquired in step S003 (step S006).

When receiving a response, which indicates that the requested virtual port has been created, from the VIM 104b (an arrow indicated by a dashed line in FIG. 10), the orchestrator apparatus 100 requests the VIM 104b to create a VM by specifying the IP and MAC addresses of the created virtual port (step S007). The VIM 104b creates a VM by using the specified IP and MAC addresses.

As described above, the present exemplary embodiment enables not only connection of virtual networks configured by two or more VIMs (virtualized infrastructure management units) but also effective utilization of resources of two VIMs.

While exemplary embodiments of the present invention have thus been described, the present invention is not limited thereto. Further variations, substitutions, or adjustments can be made without departing from the basic technical concept of the present invention. For example, the configurations of the networks, the configurations of the elements, and the representation modes of the messages illustrated in the drawings have been used only as examples to facilitate understanding of the present invention. Namely, the present invention is not limited to the configurations illustrated in the drawings.

Finally, suitable modes of the present invention will be summarized.

[Mode 1]

(See the orchestrator apparatus according to the above first aspect)

[Mode 2]

The orchestrator apparatus according to mode 1,
wherein, when the orchestrator apparatus receives an instruction for creating a virtual machine on the first virtualized infrastructure from an upper apparatus, if a virtual machine cannot be created on the first virtualized infrastructure management unit, the orchestrator apparatus causes the second virtualized infrastructure management unit to create a virtual machine on the second virtualized infrastructure by using an address(es) created by the address management function of the first virtualized infrastructure management unit.

[Mode 3]

The orchestrator apparatus according to mode 1 or 2,
wherein where to arrange the address management function is determined when a virtual network virtually connectable to a virtual network created by one of the first and second virtualized infrastructure management units is created.

[Mode 4]

The orchestrator apparatus according to mode 3,
wherein where to arrange the address management function is determined based on amounts of available resources of the first and second virtualized infrastructure management units.

[Mode 5]

The orchestrator apparatus according to any one of modes 1 to 4,
wherein the virtualized infrastructure control unit supplies at least a network type and a network ID as the information about the virtual network.

[Mode 6]

The orchestrator apparatus according to any one of modes 1 to 5,
wherein the virtual machine creation control unit selects the first or second virtualized infrastructure on which a virtual machine is to be created, based on a predetermined rule.

[Mode 7]

(See the virtual network function providing system according to the above second aspect)

[Mode 8]

(See the virtual machine creation method according to the above third aspect)

[Mode 9]

(See the computer program according to the above fourth aspect) The above modes 7 to 9 can be expanded to modes 2 to 6 in the same way as mode 1 is expanded to modes 2 to 6.

The disclosure of the above NPL is incorporated herein by reference thereto. Variations and adjustments of the exemplary embodiments and examples are possible within the scope of the overall disclosure (including the claims) of the present invention and based on the basic technical concept of the present invention. Various combinations and selections of various disclosed elements (including the elements in each of the claims, exemplary embodiments, examples, drawings, etc.) are possible within the scope of the disclosure of the present invention. Namely, the present invention of course includes various variations and modifications that could be made by those skilled in the art according to the overall disclosure including the claims and the technical concept. The description discloses numerical value ranges. However, even if the description does not particularly disclose arbitrary numerical values or small ranges included in the ranges, these values and ranges should be deemed to have specifically been disclosed.

### REFERENCE SIGNS LIST

100 orchestrator apparatus
101 virtualized infrastructure control unit
102 virtual machine creation control unit (VM creation control unit)
104a, 104b VIM
106 maintenance terminal

1. An orchestrator apparatus,
connected to a first virtualized infrastructure management unit that includes an address management function and manages a first virtualized infrastructure and to a second virtualized infrastructure management unit that manages a second virtualized infrastructure, and
comprising:
a virtualized infrastructure control unit that supplies information about a virtual network created by one of the first and second virtualized infrastructure management units to the other virtualized infrastructure management unit and causes the other virtualized infrastructure management unit to create a virtual network virtually connectable to the virtual network created by said one virtualized infrastructure management unit; and
a virtual machine creation control unit that causes, when a virtual machine is created on the second virtualized infrastructure, the address management function of the first virtualized infrastructure management unit to create an address(es) that is to set in a virtual port of the virtual machine, supplies the address(es) to the second virtualized infrastructure, and causes the second virtualized infrastructure management unit to create a virtual machine on the second virtualized infrastructure.

2. The orchestrator apparatus according to claim 1, wherein, when the orchestrator apparatus receives an instruction for creating a virtual machine on the first virtualized infrastructure from an upper apparatus, if a virtual machine cannot be created on the first virtualized infrastructure management unit, the orchestrator apparatus causes the second virtualized infrastructure management unit to create a virtual machine on the second virtualized infrastructure by using an address(es) created by the address management function of the first virtualized infrastructure management unit.

3. The orchestrator apparatus according to claim 1, wherein where to arrange the address management function is determined when a virtual network virtually connectable to a virtual network created by one of the first and second virtualized infrastructure management units is created.

4. The orchestrator apparatus according to claim 3, wherein where to arrange the address management function is determined based on amounts of available resources of the first and second virtualized infrastructure management units.

5. The orchestrator apparatus according to claim 1, wherein the virtualized infrastructure control unit supplies at least a network type and a network ID as the information about the virtual network.

6. The orchestrator apparatus according to claim 1, wherein the virtual machine creation control unit selects the first or second virtualized infrastructure on which a virtual machine is to be created, based on a predetermined rule.

7. A virtual network function providing system, comprising the orchestrator apparatus according to claim 1.

8. A virtual machine creation method, executed by an orchestrator apparatus connected to a first virtualized infrastructure management unit that includes an address management function and manages a first virtualized infrastructure and to a second virtualized infrastructure management unit that manages a second virtualized infrastructure, the virtual machine creation method comprising:
supplying information about a virtual network created by one of the first and second virtualized infrastructure management units to the other virtualized infrastructure management unit and causing the other virtualized infrastructure management unit to create a virtual network virtually connectable to the virtual network created by said one virtualized infrastructure management unit; and
causing, when a virtual machine is created on the second virtualized infrastructure, the address management function of the first virtualized infrastructure management unit to create an address(es) that is to set in a virtual port of the virtual machine, supplying the address(es) to the second virtualized infrastructure, and causing the second virtualized infrastructure management unit to create a virtual machine on the second virtualized infrastructure.

9. A non-transitory computer-readable recording medium storing thereon a program, causing a computer, which constitutes an orchestrator apparatus connected to a first virtualized infrastructure management unit that includes an address management function and manages a first virtualized infrastructure and to a second virtualized infrastructure management unit that manages a second virtualized infrastructure, to perform processing for:
supplying information about a virtual network created by one of the first and second virtualized infrastructure management units to the other virtualized infrastructure management unit and causing the other virtualized infrastructure management unit to create a virtual network virtually connectable to the virtual network created by said one virtualized infrastructure management unit; and
causing, when a virtual machine is created on the second virtualized infrastructure, the address management function of the first virtualized infrastructure management unit to create an address(es) that is to set in a virtual port of the virtual machine, supplying the address(es) to the second virtualized infrastructure, and causing the second virtualized infrastructure management unit to create a virtual machine on the second virtualized infrastructure.

10. The orchestrator apparatus according to claim 2, wherein where to arrange the address management function is determined when a virtual network virtually connectable to a virtual network created by one of the first and second virtualized infrastructure management units is created.

11. The orchestrator apparatus according to claim 10, wherein where to arrange the address management function is determined based on amounts of available resources of the first and second virtualized infrastructure management units.

12. The orchestrator apparatus according to claim 2, wherein the virtualized infrastructure control unit supplies at least a network type and a network ID as the information about the virtual network.

13. The orchestrator apparatus according to claim 3, wherein the virtualized infrastructure control unit supplies at least a network type and a network ID as the information about the virtual network.

14. The orchestrator apparatus according to claim 4, wherein the virtualized infrastructure control unit supplies at least a network type and a network ID as the information about the virtual network.

15. The orchestrator apparatus according to claim 2, wherein the virtual machine creation control unit selects the first or second virtualized infrastructure on which a virtual machine is to be created, based on a predetermined rule.

16. The orchestrator apparatus according to claim 3, wherein the virtual machine creation control unit selects the first or second virtualized infrastructure on which a virtual machine is to be created, based on a predetermined rule.

17. The orchestrator apparatus according to claim 4, wherein the virtual machine creation control unit selects the first or second virtualized infrastructure on which a virtual machine is to be created, based on a predetermined rule.

18. The orchestrator apparatus according to claim 5, wherein the virtual machine creation control unit selects the first or second virtualized infrastructure on which a virtual machine is to be created, based on a predetermined rule.
